(19) United States
(12) Patent Application Publication
(10) Pub. No.: US 2007/0174161 A1
(43) Pub. Date: Jul. 26, 2007

(54) Method and System for Creating a Plan of Projects

(75) Inventors: Andrew Bullock, London (GB); Jonathan Burton, London (GB)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GmbH, Schaffhausen (CH)

(21) Appl. No.: 11/275,741

(22) Filed: Jan. 26, 2006

(51) Int. Cl. G06Q 40/00

(52) U.S. Cl. 705/35

(57) ABSTRACT

A method of creating a plan of projects to invest in for an investment program. The investment program is for a period of time, for example 5 years. A plurality of investment projects are defined. Each investment project has at least one resource requirement (e.g. a project cost and/or an effort requirement). At least one project benefit score is determined for each investment project. The project benefit score for an investment project indicates the benefit of performing the investment project. Resource constraints are defined for the investment program. The resource constraints comprise for each of a plurality of sub-periods of time (e.g. particular years) within the period of time of the investment program, at least one resource constraint which constrains the resource available for investing in projects for the sub-period. The resource requirements, project benefit scores and resource constraints are provided as inputs to a risk reduction procedure which determines a plan for the investment program. The plan identifies for each sub-period of time particular investment projects to invest in. The risk reduction procedure is arranged to produce a plan which satisfies the resource constraints and reduces residual risk, the residual risk comprising the combined project benefit scores of unperformed investment projects.

### BACKGROUND OF THE INVENTION

1. Field of the Invention

The present invention relates to a method and system for creating a plan of projects to invest in as part of an investment program. The invention particularly, but not exclusively, relates to creating a plan for a network utility (e.g. gas, electricity or water) investment program.

2. Description of the Related Art

In many circumstances it is desirable to plan which projects to invest in. An organization such as a network utility organization which supplies water, for example, needs to plan which assets (e.g. which parts of their infrastructure such as particular pipelines and treatment equipment) to invest in as part of maintenance, repair and replacement programs, for example.

A known approach for planning which projects to invest in is to use a simple spreadsheet-based prioritization tool to define investment projects. A project cost and a project benefit score is associated with each investment project. The project benefit score for an investment project indicates the overall benefit of performing the investment project. In the known approach, the projects are listed in order (i.e. prioritized) from the one with the highest project benefit score to one with the lowest. A list of which projects to perform in a single year is then derived by listing each project in turn from the top of the list downwards, taking account of the cost of each project until the year's budget has been used up. In other words, a line would be drawn where the budget is exceeded. Those projects falling under the line would be postponed. Towards the end of the year a similar process of planning would be performed for the next year, and so on.

Another proposal for planning which projects to invest in is to use UMS's Portfolio Optimization Process (POP) tool.

Embodiments of the present invention seek to provide an improved method and system for creating a plan of projects to invest in for an investment program.

### SUMMARY OF THE INVENTION

An embodiment of the present invention relates to a method of creating a plan of projects to invest in for an investment program. The investment program is for a period of time, for example 5 years. A plurality of investment projects are defined. Each investment project has a resource requirement (e.g. a project cost and/or an effort requirement). A project benefit score is determined for each investment project. The project benefit score for an investment project indicates the benefit of performing the investment project. Resource constraints are defined for the investment program. The resource constraints comprise for each of a plurality of sub-periods of time (e.g. particular years) within the period of time of the investment program, a resource constraint which constrains the resource available for investing in projects for the sub-period. The resource requirements, project benefit scores and resource constraints are provided as inputs to a risk reduction procedure which determines a plan for the investment program. The plan identifies for each sub-period of time particular investment projects to invest in. The optimization procedure is arranged to produce a plan which satisfies the resource constraints and reduces residual risk, the residual risk comprising the combined project benefit scores of unperformed investment projects.

Another embodiment of the present invention relates to a system for creating a plan of projects to invest in for an investment program.

Advantageously, using a risk reduction procedure to determine a plan over a period of time (e.g. 5 years) with projects to invest in identified in each sub-period of time (e.g. particular years), a plan with reduced residual risk over time can be created.

Some embodiments of the invention may include or utilize computer-executable instructions for performing one or more of the disclosed methods. The computer-executable instructions may be stored on a computer-readable medium, such as a portable memory drive or CD-ROM

Other advantages of embodiments of the invention will be apparent from the following description.

### BRIEF DESCRIPTION OF THE DRAWINGS

Particular embodiments of the invention will now be described, by way of example only, with reference to the accompanying drawings, in which:

FIG. 1 illustrates the components of an embodiment of the present invention;

FIG. 2 is a flow diagram showing the functional steps of an embodiment of the present invention;

FIG. 3 illustrates a particular implementation of an embodiment of the present invention;

FIG. 4 is a flow diagram showing the functional steps of an embodiment of the present invention;

FIG. 5 is a flow diagram showing the functional steps of an embodiment of the present invention;

FIG. 6 shows an interface of a tool for defining a hierarchy of investment attributes for the investment program in an embodiment of the present invention;

FIG. 7 shows an interface of a tool which maps each quantifiable investment attribute to each investment project in an embodiment of the present invention;

FIG. 8 shows an interface of a tool on which weightings for one or more investment attributes can be assigned in an embodiment of the present invention;

FIG. 9 shows an interface of a tool on which a score for each quantifiable investment attribute for each investment project can be assigned in an embodiment of the present invention;

FIG. 10 shows an interface of a tool on which a prioritized list of the investment projects prioritized from the project with the highest project benefit score to the project with the lowest project benefit score is displayed in an embodiment of the present invention;

FIG. 11 shows an interface of a tool on which the project benefit score for investment projects by contribution from each investment attribute from a first level of the hierarchy of investment attributes is displayed in an embodiment of the present invention;

FIG. 12 shows an interface illustrating a score for a quantifiable investment attributes which has a variable character;

FIG. 13 shows an interface illustrating a prioritized list including an indication of the range of probable scores for projects having quantifiable investment attributes of a variable character;

FIG. 14 shows an initial rough cut plan in an embodiment of the present invention;

FIG. 15 illustrates an interface showing inputs and outputs for an optimization procedure as the risk reduction procedure in an embodiment of the present invention;

FIG. 16 illustrates an interface showing resource inputs for an optimization procedure as the risk reduction procedure in an embodiment of the present invention;

FIG. 17 illustrates an audit trail of an embodiment of the present invention;

FIG. 18 illustrates an interface showing inputs and outputs for an optimization procedure as the risk reduction procedure in an embodiment of the present invention;

FIG. 19 illustrates the effect of risk reduction in an embodiment of the present invention;

FIG. 20 illustrates residual risk for a rough cut plan of an embodiment of the present invention;

FIG. 21 illustrates residual risk having used the a risk reduction procedure in an embodiment of the present invention;

FIG. 22 shows a data model for an embodiment of the present invention;

FIG. 23 is a flow diagram showing the functional steps of an risk reduction procedure in an embodiment of the present invention;

FIG. 24 illustrates an optimization procedure as the risk reduction procedure of an embodiment of the present invention; and

FIG. 25 illustrates an architecture of a computer system on which an embodiment of the present invention can be implemented.

### DETAILED DESCRIPTION OF PARTICULAR EMBODIMENTS

Overview

Embodiments of the present invention relate to methods and systems for creating plans of projects to invest in as part of an investment program. Whereas prior approaches only produce a simple prioritized list of projects for a single time period, for example a year, embodiments of the present invention provide a plan for a time period with projects to invest in identified sub-periods of time which is optimized to reduce residual risk over time.

In one embodiment the period of time is a plurality of years (e.g. 5 or 10 years) and the sub-periods of time are particular years (e.g. 2006, 2007, 2008, 2009 and 2010 for a 5 year investment program). Some embodiments have an additional sub-period which extends beyond the investment program, e.g. “2011 onwards” for a 5 year plan in which projects which are not identified in the plan are placed. The period of time and sub-periods may be any suitable periods for the particular investment program. For example, in other embodiments the period of time may be a year and the sub-periods may be months or quarter years.

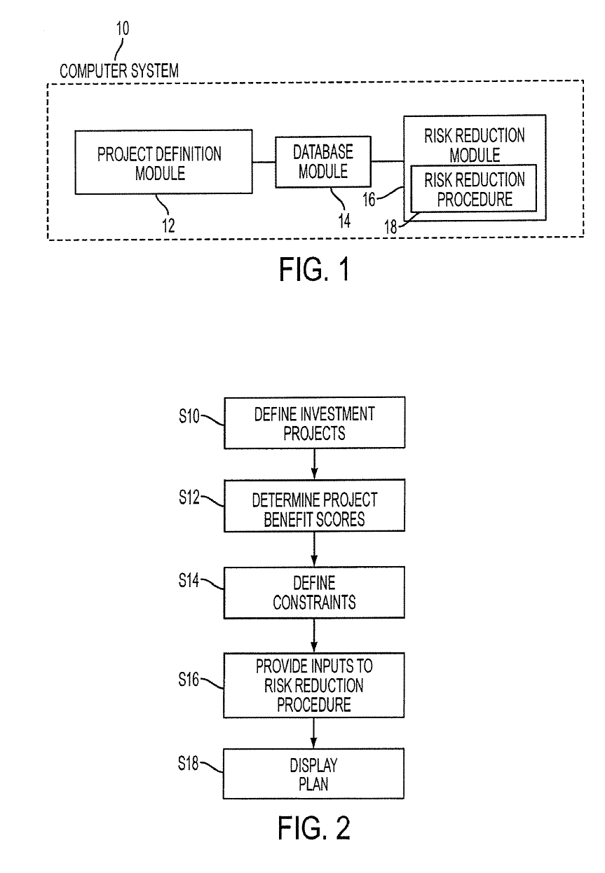

FIG. 1 illustrates the components of an embodiment of the present invention. In FIG. 1, computer system 10 comprises a project definition tool or module 12, a database tool or module 14 and an risk reduction tool or module 16. The risk reduction module 16 has an risk reduction procedure 18. As shown in FIG. 1, each of project definition module 12 and risk reduction module 16 can communicate with database module 14. The risk reduction module 16 can be an optimization module and the risk reduction routine 18 can be an optimization routine in one or more embodiments of the invention.

FIG. 2 is a flow diagram showing the functional steps of an embodiment of the present invention. In FIG. 2, at step S10 the investment projects are defined by a user using the project definition module 12. A resource requirement is defined for each investment project.

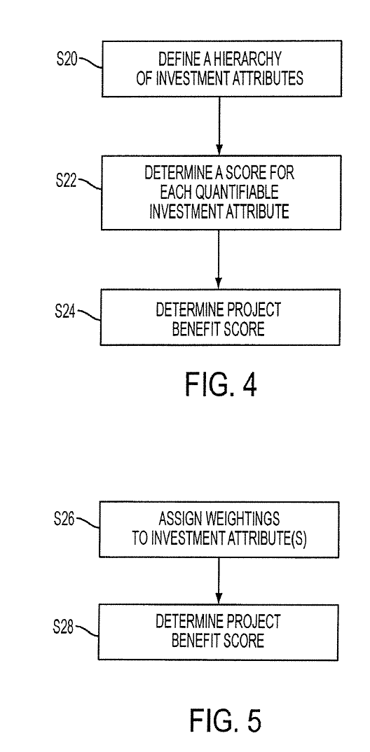

Optionally, in step S10 the structure for the investment scoring hierarchy is determined and the relative importance of each of the factors within the hierarchy are defined through the input of weights for each factor (see the description of FIGS. 4 and 5).

At step S12, project definition scores are determined for each investment project. The project benefits score for a project indicates the benefit of performing the investment project, for example in terms of benefit to the environment or company's reputation. The user uses project definition module 12 to determine these scores, which are then stored in database module 14.

At step S14 resource constraints are defined for the investment program. The resource constraints comprise for each sub-periods of time (e.g. each year of a 5 year plan), a resource constraint (e.g. a capital constraint such as a capital (financial) cap on expenditure for the sub-period) which constrains the resource available (e.g. money) for investing in projects for the sub-period. Optionally, constraints are also defined for whether each project must or must not occur, the years in which each project may occur and the timing dependencies between each of the projects. In one embodiment the constraints are defined using database module 14 and the constraints are stored in the database.

It will be apparent to the person of ordinary skill in the art that the resource constraints can be for any other variable that has to be factored in when planning for an investment program. For example, other resources subject to constraints may include labor, equipment or environmental constraints, such as carbon emissions. Suitable constraints or combinations of constraints for a particular application will be apparent to the person of ordinary skill in the art.

At step S16, the resource requirements, project benefit scores and resource constraints are provided as inputs to the risk reduction procedure 18. The risk reduction procedure 18 determines a plan for the investment program. The risk reduction procedure 18 is arranged to produce a plan which satisfies the resource constraints (e.g. the capital spend for each sub-period does not exceed the capital cap for the sub-period) and reduces residual risk.

The residual risk comprises the combined project benefit scores of the investment projects which are not performed (unperformed projects). In other words, each project has a project benefit score and if the project is performed then that benefit is gained. However, if the project is not performed then that benefit is not gained and the project benefit score for the unperformed project remains a risk.

In embodiments of the invention, the risk reduction procedure can be arranged with a function such as an objective function one or more of the following objectives: (i) to reduce the residual risk for one or more particular sub-periods of time (i.e. projects not performed in the one or more periods contribute to the residual risk), (ii) to reduce the residual risk for each sub-period of time (i.e. projects not performed before or in each sub-period contribute to the residual risk) or (iii) to reduce the residual risk for the end of the time period of the investment program (i.e. projects not performed in the plan contribute to the residual risk).

In one or more embodiments of the invention, the objectives (i), (ii) or (iii) above may be, rather than “to reduce” the specified residual risk, alternatively or additionally “to selectively reduce”, “to substantially minimize”, “selectively minimize” or “to minimize”. For example, in an embodiment with an optimization procedure as the risk reduction procedure, the procedure can be arranged with an objective function: (i) to substantially or selectively minimize the residual risk for one or more particular sub-periods of time (i.e. projects not performed in the one or more periods contribute to the residual risk), (ii) to selectively or substantially minimize the residual risk for each sub-period of time (i.e. projects not performed before or in each sub-period contribute to the residual risk) or (iii) to selectively or substantially minimize the residual risk for the end of the time period of the investment program (i.e. projects not performed in the plan contribute to the residual risk).

The plan output by the risk reduction procedure identifies for each sub-period of time particular investment projects to invest in. At step S18, the plan is displayed, in this embodiment by the database module 14 on a display of computer system 10.

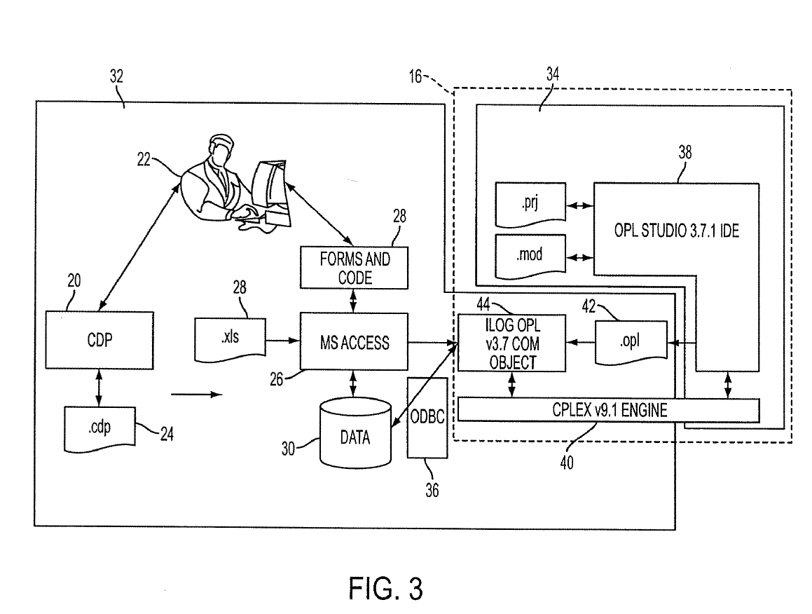

The project definition tool or module 12, database tool or module 14 and risk reduction tool or module 16 of FIG. 1 together form an investment planning workbench. There are various ways in which such a workbench can be implemented and FIG. 3 illustrates one particular implementation of an investment planning workbench. The particular implementation has an execution environment 32 and a development environment 34.

### EXAMPLE IMPLEMENTATION

Referring to FIG. 3, as an implementation of one embodiment of the invention, project definition module 12 can be provided by Criterium Decision Plus (CDP) which is a Microsoft Windows decision manager available from InfoHarvest, Inc. (www.infoharvest.com). In this implementation, CDP (CDP tool 20 in FIG. 3) is used for the collation of ideas about the weightings and scorings of investments and the generation of a prioritized list of investments. A user 22 can use CPD tool 20 to create .cdp files 24.

Database module 12 can be provided by a Microsoft Access database; Microsoft Access is available from Microsoft Corporation. Microsoft Access (MS Access 26 in FIG. 3) is used for the viewing of information of the investment projects, the entry of constraints on the investment projects, the triggering of the risk reduction routine, in this implementation an optimization routine, and the tabular and graphical display of the results. In this implementation, data from CDP tool 20 can be imported into MS Access 26 using an excel file (depicted by .xls file 28). The interaction between the user 22 and MS Access is via forms and code 28 and the data itself is stored in database 30.

Risk reduction module 16, in this implementation an optimization module, can be provided by ILOG's optimization programming language (OPL) and CPLEX, available from ILOG, Inc. (www.ilog.com), which is used for the design and execution of the optimization procedure or routine.

In a development environment 34, OPL Studio 3.7.1 IDE 38 is used to develop the optimization tool. This interacts with the CPLEX v9.1 Engine 40 and produces opl files 42 for the ILOG OPL v3.7 COM Object 44 which contain a definition of the optimization comprising an objective function to substantially or selectively minimize residual risk such as to substantially or selectively minimize overall residual risk across all years of the plan, and constraints.

The ILOG OPL v3.7 COM Object 44 interacts with MS Access and the database using COM and Open Database Connectivity (ODBC 36). In this implementation the optimization engine 40 imports a set of data from MS Access 26 consisting of problem data (e.g. projects, resource requirements, dependencies, etc.), generates an optimal solution to the objective function (using Mixed Integer Programming (MIP) and optionally non-linear MIP) and exports the data back to MS Access. Determining the project definition scores and prioritization

FIG. 4 is a flow diagram showing the functional steps of an embodiment of the present invention which determines a project benefit score for each investment project.

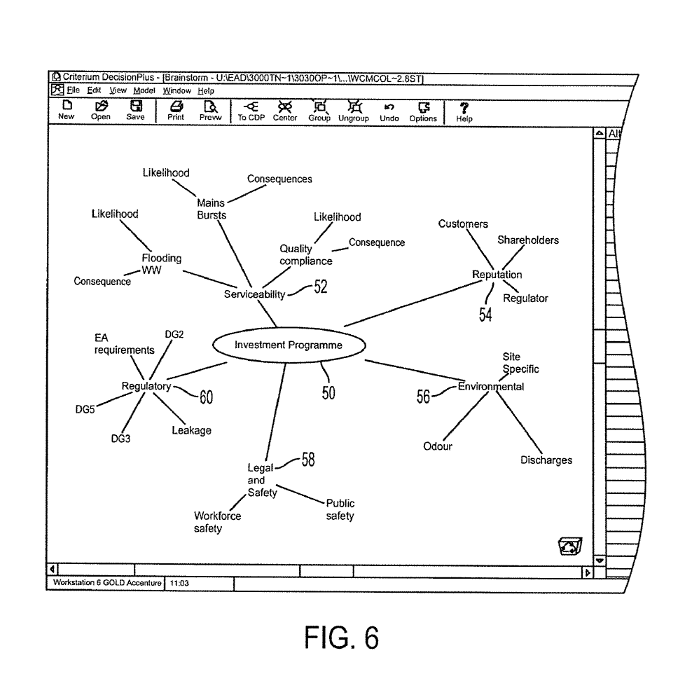

At step S20, a hierarchy of investment attributes for the investment program is defined by the user. FIG. 6 illustrates how the user can define such a hierarchy using the CDP tool 20. In this example, which is for an investment program for a water utility company, the investment program 50 is represented at the centre of the interface. At a first level of the hierarchy of investment attributes comprise serviceability 52; reputation 54; environmental 56; legal and safety 58; and regulatory 60. The hierarchy progresses to a second level all of these attributes or criteria and to a third level for serviceability 52 as shown.

At the lowest level in the hierarchy, e.g. level 3 for Serviceability and level two for the other four attributes in this example, there are quantifiable investment attributes on which an investment project can be scored.

The stage, referred to as the logic definition stage, advantageously, can be done within a workshop environment where all investment planning staff build up a picture of the attributes of an investment program. Any number of branches can be defined, some of which will only be relevant to certain types of investment program (e.g. serviceability drivers for capital maintenance program).

Advantageously, this enables full understanding of the logic behind the project definitions.

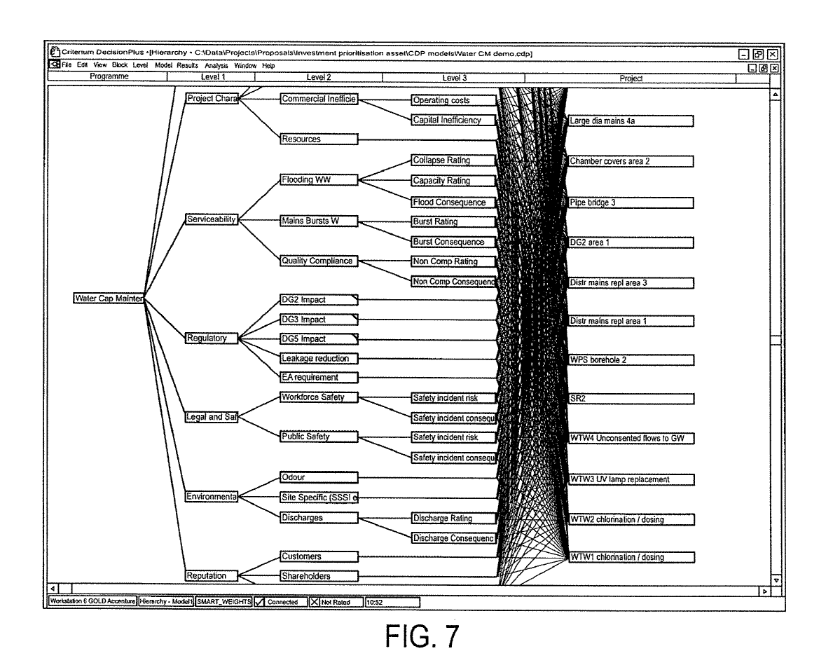

At step S22 a score for each quantifiable investment attribute is given for each project. The relationships between projects on the right and the quantifiable investment attributes on the left is shown in FIG. 7. The CDP tool 20 provides this interface. There is a relationship (line) between all projects and all investment attributes in the Figure and each investment project is scored on each of the attributes.

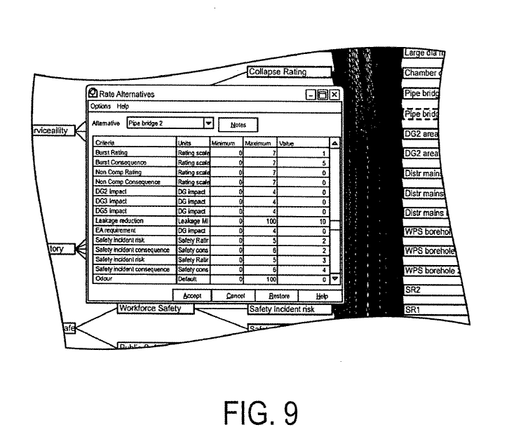

FIG. 9 shows an interface of the CDP tool 20 which enables a user to input the scores. In this example, a pipe bridge has a high consequence but low probability of burst, which contribute to the serviceability driver. These scores are typically provided from the company's asset analytical tools, but may be estimated if need be.

At step S24 the project benefit score is determined for each project based on the scores for each quantifiable investment attribute for the investment project, for example by adding all of the scores for each investment attribute for the investment project.

FIG. 5 is a flow diagram showing the functional steps of an embodiment of the present invention. In this embodiment determining a project benefit score for each investment project comprises, at step S26 assigning weightings for one or more investment attributes; and, at step S28, determining the project benefit score for each investment project based on the scores for each quantifiable investment attribute for the investment project and the weightings for the one or more investment attributes.

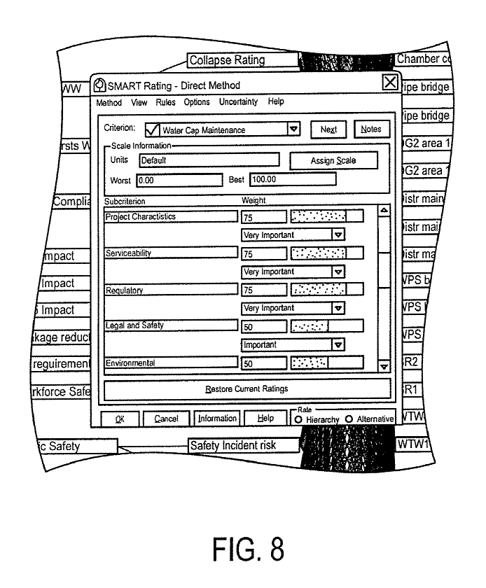

FIG. 8 shows an interface of the CDP tool 20 which allows weightings to be assigned by the user. As can be seen, in this embodiment contributions are weighted, working from program level down to the lowest or smallest level in the hierarchy. For example, in this case project characteristics (i.e. commercial contribution), serviceability and other regulatory drivers are weighted equally. Legal and safety and environmental drivers are weighted lower.

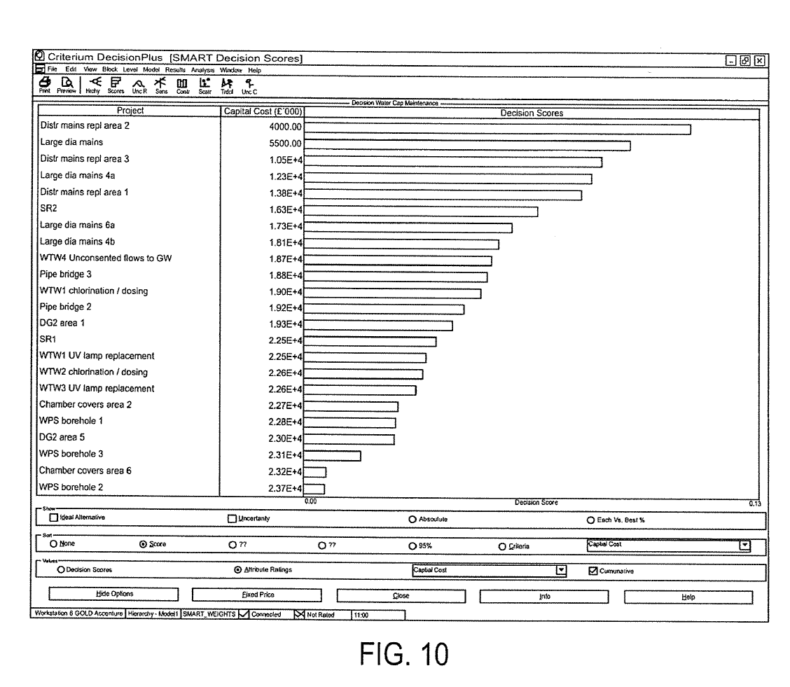

When the logic is clearly set out, the structure is exported directly into a hierarchy of expenditure attributes that drive a prioritization engine within the project definition module. The prioritization engine determines a prioritized list of the investment projects prioritized from the project with the highest project benefit score to the project with the lowest project benefit score; and displays the prioritized list as shown in FIG. 10.

As can be seen from FIG. 10, the initial output from the prioritization engine consists of a prioritized or weighted list of projects by program. In this example, for a capital maintenance program the highest benefit investment is the replacement of mains in area 2. The score is based on the weighted attribute scores defined in the logic stage and cumulative capital cost is shown in the middle column. Typically in prior approaches which used a CDP tool on its own (with no reduced risk reduction or plan including sub-periods) companies would draw a line where their budget lies and those projects falling under the line would be postponed.

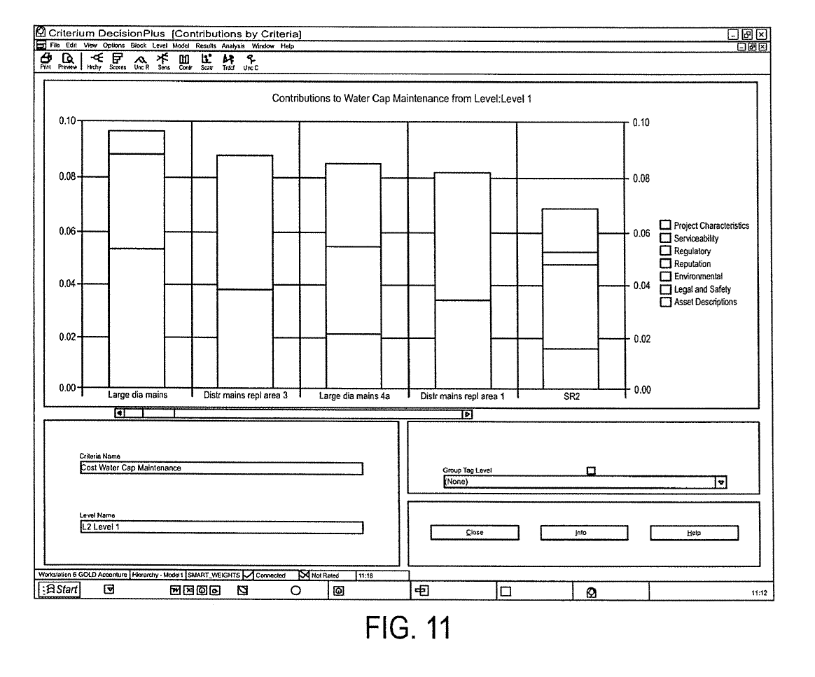

In one embodiment, the project benefit score for each investment project is displayed by contribution from each investment attribute from a particular level of the hierarchy of investment attributes. An example of this for level 1 of the hierarchy is shown in FIG. 11. In this example, serviceability is the common driver to each of the projects (from left column to right serviceability is middle, bottom, middle, bottom and second up contribution for respective bars), although there is a large commercial aspect to the large diameter mains project, and safety issues (uppermost contribution on the bar) on the SR2 project. Review of prioritization list can help ensure that users can sense-check prioritization of investments and review the weightings and scores.

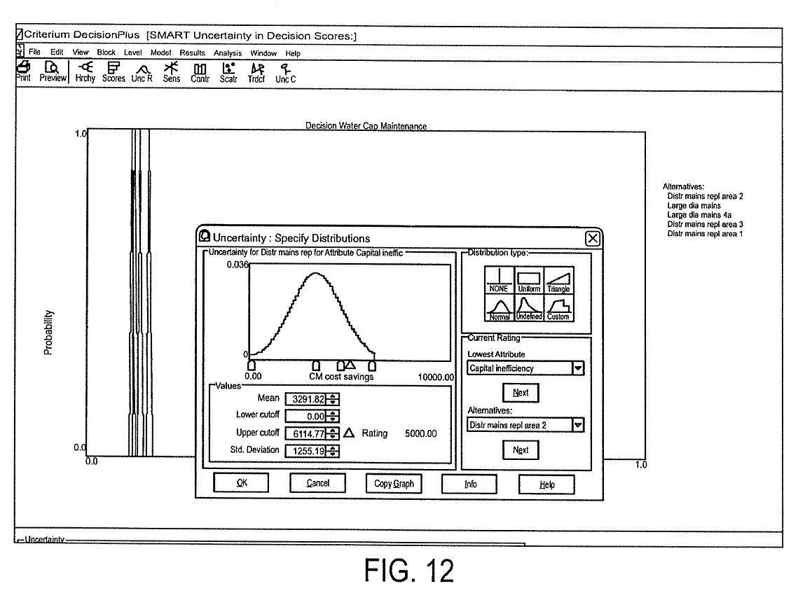

In a particular embodiment, a score for one or more quantifiable investment attributes for one or more investment projects has a variable character. For example, the largest scoring project of FIGS. 10 and 11 has an element of commercial return in the form of improving capital efficiency. If there is not full confidence in the underlying analytical tools data used to estimate the capital return, a probability curve can be entered instead of a definite score. FIG. 12 illustrates an interface displaying an example probability curve.

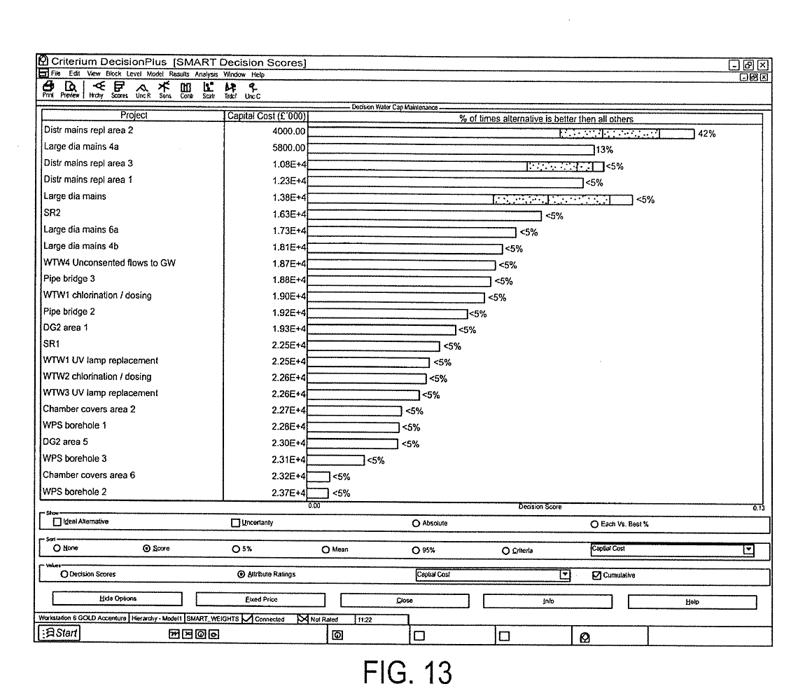

Such an embodiment can demonstrate the effect of input uncertainty on program prioritization as shown in FIG. 13. A review of the mean scores shows that the highest scoring project would now only be top 42% of the time.

Advantageously, it can be seen that such an embodiment, can deal with uncertainty on inputs and identify sensitivities on prioritization

Risk Reduction Module and Risk Reduction Procedure

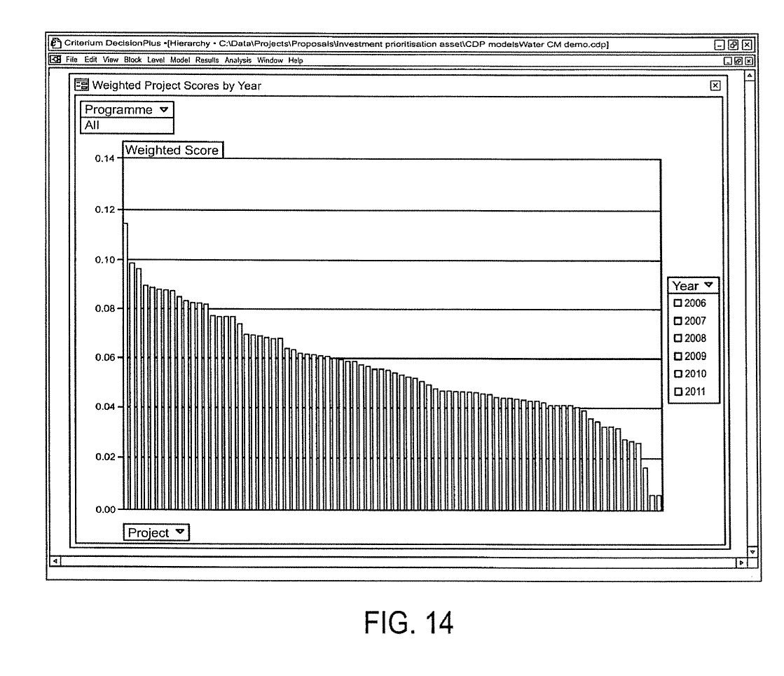

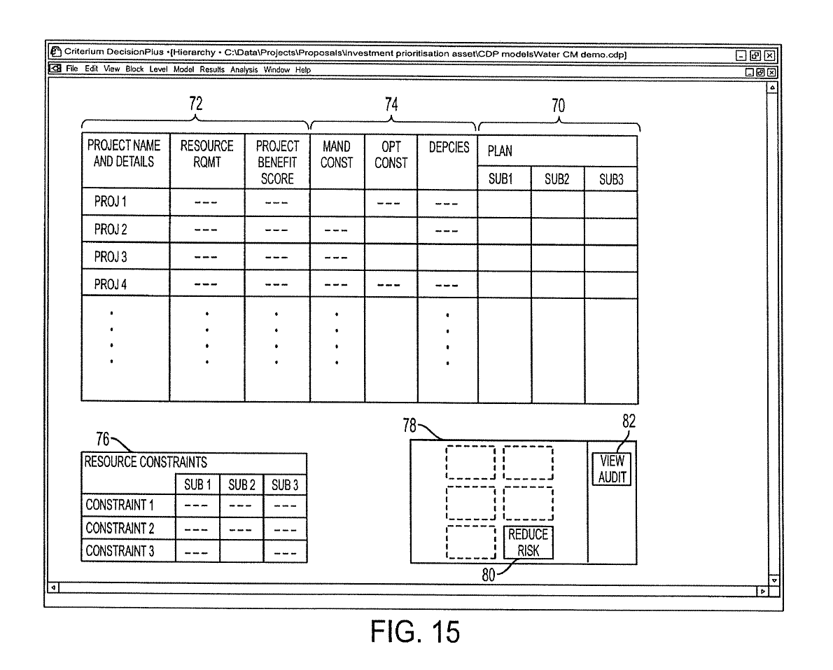

When the program managers are content with the prioritized list developed in the project definition module, the data is passed to the database module 14 which links to the risk reduction module 16. Here, for comparative purposes, a rough cut plan can be produced by allocating the projects with the highest benefit score into the first year of the plan and continuing to add the projects until the capital or resource constraints for that year are exceeded (this is a similar process to known techniques—i.e. the rough cut plan simulates the manual process of planning). It then fills in the next year until all years are full. The rough cut plan consists of the projects taken directly from the prioritization engine and is shown in FIG. 14. As can be seen from the Figure, the highest scoring projects are planned early within the planning period.

In one or more embodiments of the invention the risk reduction module can be an optimization module and the risk reduction procedure can be an optimization procedure.

FIG. 15 illustrates an interface of database module 14, used in one embodiment for the user to interact with the investment planning workbench. The data displayed on the interface is in one embodiment held in the database in multiple tables keyed primarily on project.

Inputs developed using the project definition module 12 are displayed in region 72 of the interface. These include the project name and details, here listed as “Proj 1”, “Proj 2”, “Proj 3” and “Proj 4”, a resource requirement for each project and the project benefit score for each project. The projects are listed in the prioritized order developed using the prioritization engine, although can be sorted in other orders including, cost, other resources and detailed scores.

In the first column of the region labeled as 74, mandatory occurrence constraints may be defined by the user which specify that one or more investment projects must occur (e.g. by crossing a box). In the second column of region 74 optional occurrence constraints may be defined by the user which specify that one or more investment projects may occur in one or more of the sub-periods of time (e.g. by crossing a box for each sub-period in which the project may occur). In the third column of region 74, the user may define project dependencies which specify one or more dependencies between investment projects (e.g. by defining one or more projects as having to go before or after a particular project).

In the region labeled as 76, one or more resource constraints (here “Constraint 1”, “Constraint 2” and “Constraint 3”) can be defined for each sub period (here “Sub 1”, “Sub 2” and “Sub 3”). Optionally, constraints at an overall or program level can be made.

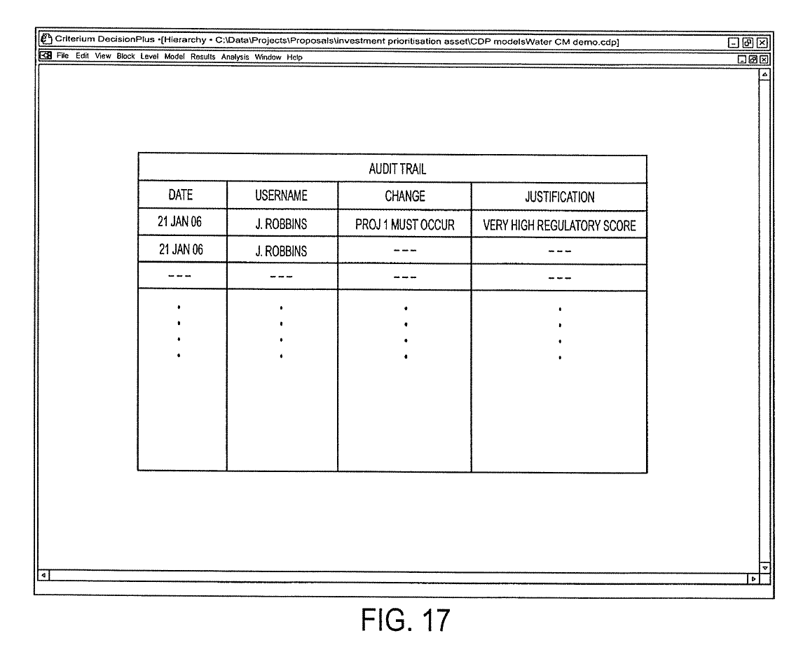

If the user changes one or more pre-defined inputs on the interface, he may be prompted to record his justification for the change, which is stored. In response to pressing button 82, an audit trail of changes can be viewed (as shown in FIG. 17). This audit capability can be used to show Regulators or people within an organization that the investment plan is justifiable.

In response to pressing button 80 (“Reduce Risk”) the risk reduction routine runs and the reduced risk plan is output to area 70, with an indication in the field for each sub-period (“Sub1”, “Sub 2” and “Sub 3”) identifying particular projects to be invested in for the particular sub period.

The “Reduce Risk” button may be an “Optimize” button which runs an optimization routine which outputs a substantially or selectively optimized plan in one or more embodiments.

In one embodiment the resource requirement for each investment project is an effort requirement and the resource constraint for each sub-period of time comprises an effort constraint which constrains the effort available for investing in projects for the sub-period.

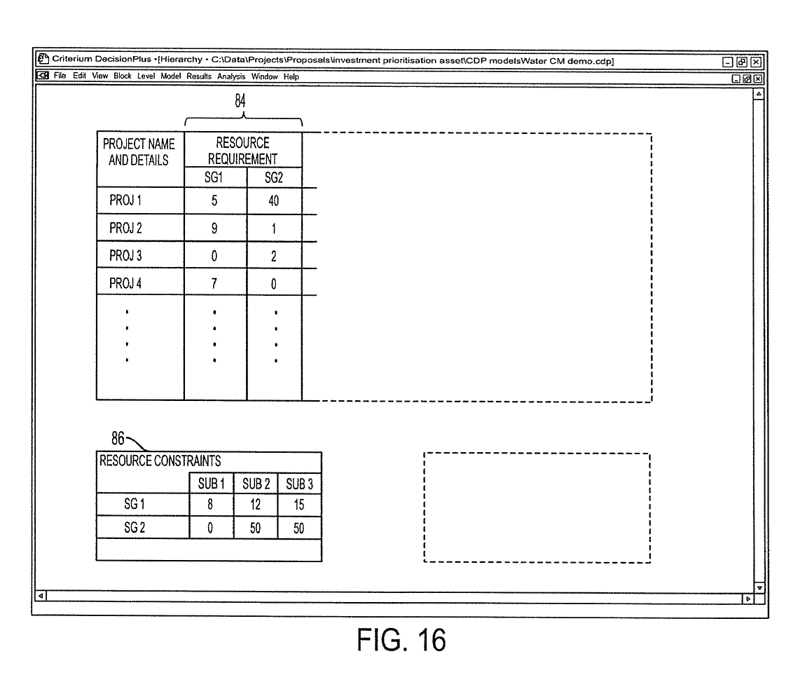

The effort requirements and effort constraints may comprise staff effort requirements and staff effort constraints defined, for example, by skill group and FIG. 16 illustrates a user interface for such an embodiment. The resource requirements 84 for each project are defined in terms of a mandays of Skill Group 1 (“SG1”) (e.g. engineers) and mandays of Skill Group 2 (“SG2”) (e.g. plumbers).

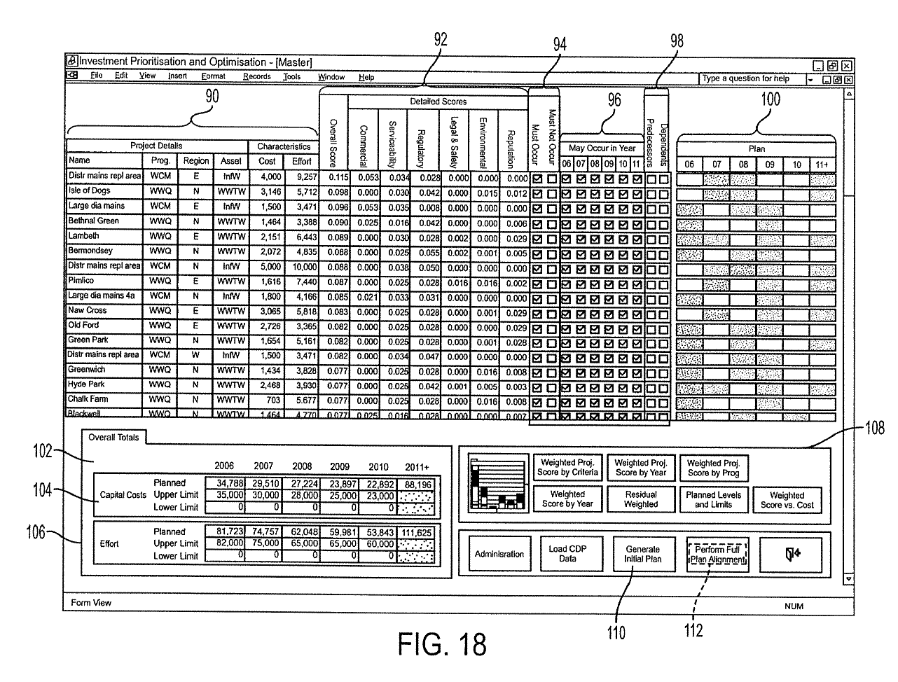

FIG. 18 shows an interface of a particular embodiment of the present invention. Inputs for project details and characteristics 90 are displayed for each project. The characteristics are the resource requirements of cost (in pounds sterling) and effort (in man-hours) for each project. The overall project benefit score and detail scores 92 are shown. Columns 94 and 96 are provided for specifying mandatory and optional occurrence constraints, respectively. Project dependencies can be defined through interaction with the fields in columns 98.

The resource constraints are shown in region 102. These include capital constraints 104 and effort constraints (in man hours) for each sub-period.

In particular embodiments, one, more or all of the following functionality is provided:

(i) clear data tables and load CDP data from a named spreadsheet;

(ii) display data for each project in a grid from database;

(iii) sort data by each sortable column;

(iv) filter data on filterable columns;

(v) show totals for capital and other resource constraints overall by year and allow their editing;

(vi) show totals for capital and other resource constraints by program by year and allow their editing;

(vii) show totals capital and other resources for planned investments by year;

(viii) show totals capital and other resources for planned investments for a program by year;

(ix) show maintenance plan as color blocks in the plan area (shown as very light shading in FIG. 18);

(x) generate a rough-cut plan;

(xi) display the plan in the plan area, integrating colors with the maintenance plan (colors represented by shading in the Figure);

(xii) generate a fully optimized plan by calling into the OPL COM object and interpreting the status passed back;

(xiii) present the following charts of data (by using buttons in area 108)

(a) Project weighted score (showing composition by criteria) by project (sorted on score descending);

(b) Project weighted score (showing year of implementation) by project (sorted on score descending);

(c) Project weighted score (showing program) by project (sorted on score descending);

(d) Project weighted score (showing composition by criteria) by year;

(e) Residual project weighted score (includes “discount” factor) by year;

(f) Budget and actual planned cost or other resource by year;

(g) Scatter chart of project score (y) by project cost or other resource (x) by implementation year (using color—not depicted)

(xiv) Modify risk increment factors from standard/flat set to rising set so that the residual risk for a project increases with time;

(xv) Modify additional constraints on project as follows:

(a) Must occur (1 control per project);

(b) Must not occur (1 control per project);

(c) May only occur in year (1 controls per project per year);

(d) Predecessors (1 control per project per project);

(e) Successors (1 control per project per project)

In another embodiment the predecessors are displayed in an x-y grid of project vs. project with a Boolean control for each intersection

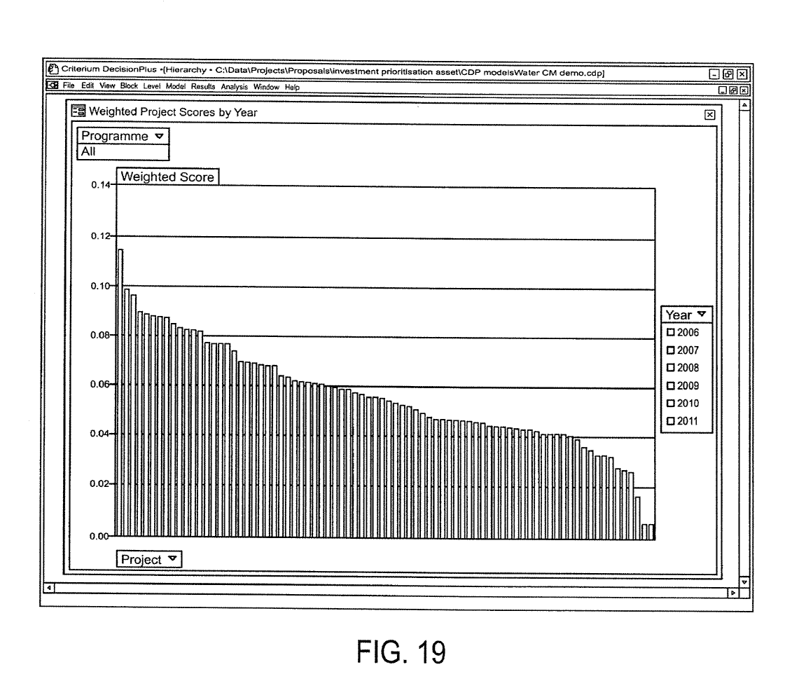

FIG. 19 illustrates the effect of risk reduction such an optimization on the timing of projects. Prior to risk reduction, a plan for investment would typically identify the greatest benefit scores as to be performed in the first year (e.g. 2006) Following risk reduction, the graph of FIG. 19 shows that projects are much more dispersed throughout the 5 year plan as those that bring the greatest benefit per investment are brought forward.

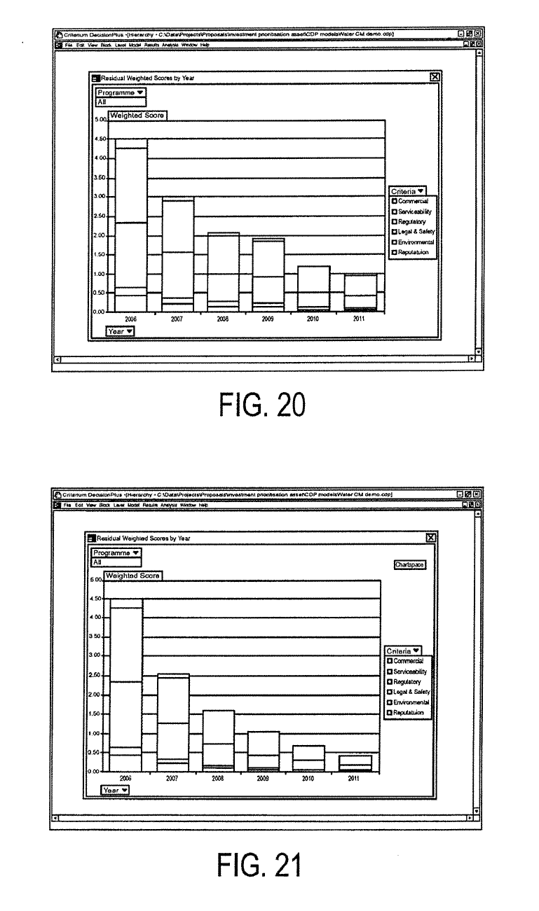

An output of from the workbench is residual risk. Residual risk can be a consideration for the whole plan or for each sub-period of the plan, and comprises the sum of the project benefit scores which have not been completed by the end of the whole plan or the end of the sub-period, respectively. The output of FIG. 20 shows the residual risk each year following the rough cut plan (i.e. non-optimized). The year 2011 stack (on the right of each graph) indicates the risk (i.e. to serviceability, health and safety, environment etc) remaining after the 5 year plan due to insufficient budget and other resources.

Using the risk reduction (e.g. optimization) capabilities of investment planning workbench reduces the residual risk by half in the year 2011, using the same resource constraints, as shown in FIG. 21. This is a powerful tool for demonstrating to a Regulator (e.g. Ofgem or Ofwat in the United Kingdom) the effects of changes in capital constraints in terms of residual risk to service.

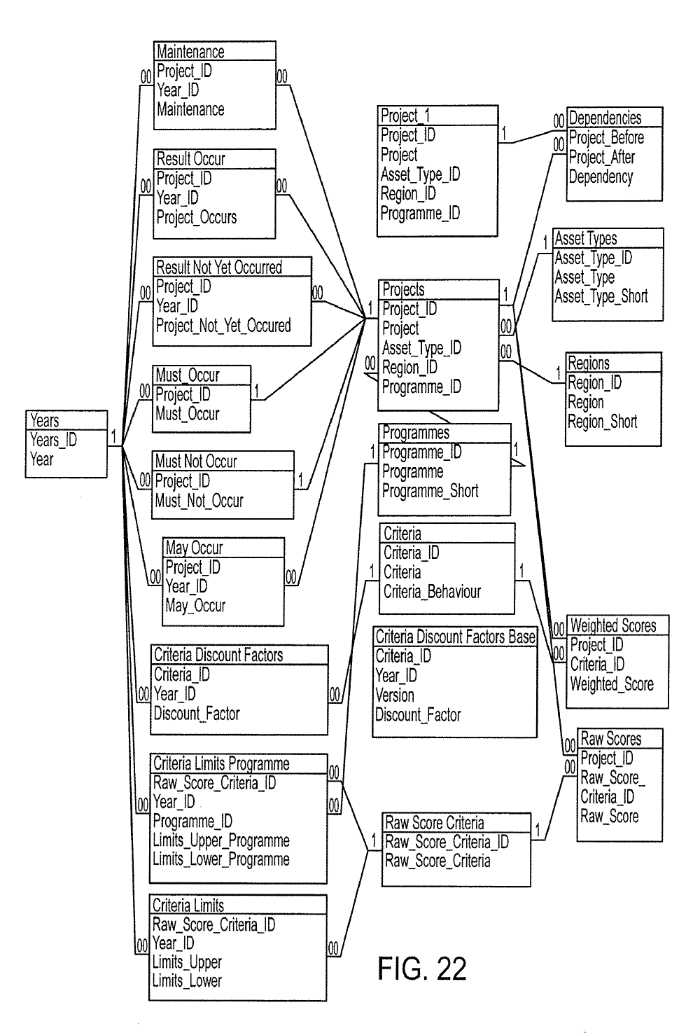

FIG. 22 illustrates the data architecture schema for storing the data displayed on the interface of FIG. 18 for a relational Microsoft Access database.

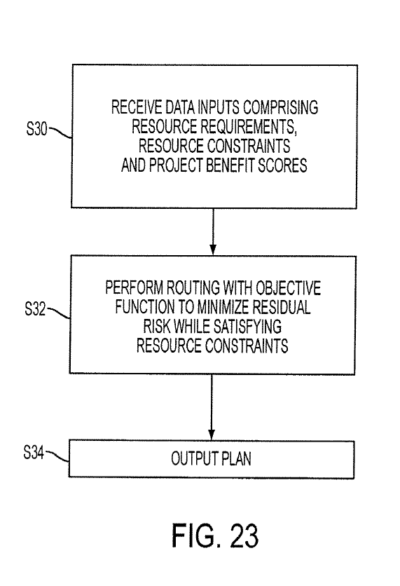

FIG. 23 illustrates the operational steps of the risk reduction procedure 18. At step S30, data inputs are received from the database. In particular embodiments, the data inputs are the data displayed on the interfaces depicted in FIGS. 15, 16 and 18 and stored in the database, for example according to the schema or FIG. 22.

In an embodiment, the data inputs comprise the resource requirements, the resource constraints and the project benefit scores. The constraints may also include the various other constraints previously described.

At step S32, the risk reduction procedure, in some embodiments an optimization procedure, is performed. The procedure has an objective function of minimizing the residual risk, whilst satisfying the resource constraints. At step S34 the reduced risk (e.g. optimized) plan is output and displayed on the interface, e.g. in regions 70 and 100 of FIGS. 15 and 18.

The benefits of the reduced risk (e.g. optimized) plan compared with the rough cut (non-optimized plan) have already been shown in FIGS. 20 and 21.

In embodiments of the invention, the risk reduction procedure can be arranged with a function such as an objective function one or more of the following objectives: (i) to reduce the residual risk for one or more particular sub-periods of time (i.e. projects not performed in the one or more periods contribute to the residual risk), (ii) to reduce the residual risk for each sub-period of time (i.e. projects not performed before or in each sub-period contribute to the residual risk) or (iii) to reduce the residual risk for the end of the time period of the investment program (i.e. projects not performed in the plan contribute to the residual risk).

In one or more embodiments of the invention, the objectives (i), (ii) or (iii) above may be, rather than “to reduce” the specified residual risk, alternatively or additionally “to selectively reduce”, “to substantially minimize”, “selectively minimize” or “to minimize”. For example, in an embodiment with an optimization procedure as the risk reduction procedure, the procedure can be arranged with an objective function: (i) to substantially or selectively minimize the residual risk for one or more particular sub-periods of time (i.e. projects not performed in the one or more periods contribute to the residual risk), (ii) to selectively or substantially minimize the residual risk for each sub-period of time (i.e. projects not performed before or in each sub-period contribute to the residual risk) or (iii) to selectively or substantially minimize the residual risk for the end of the time period of the investment program (i.e. projects not performed in the plan contribute to the residual risk).

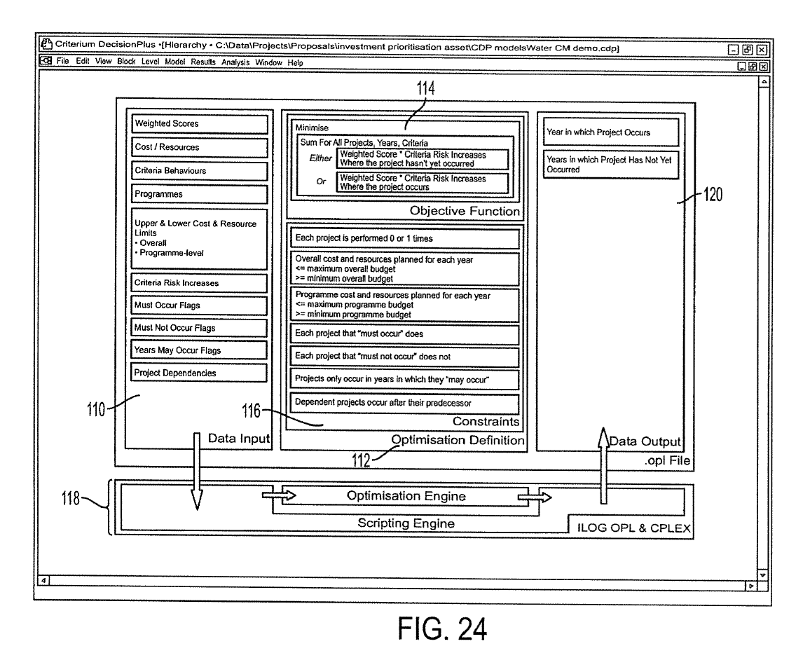

FIG. 24 shows the risk reduction procedure, here an optimization procedure, for a particular embodiment and shows the data input 110, the optimization definition 112 comprising an objective function 114 and constraints 116. The optimization procedure within optimization software 118 and data output 120 are also shown. This example uses the ILOG OPL and CPLEX optimization tool, described above with reference to FIG. 3.

Referring to FIGS. 3 and 24 in particular, the summary of the particular implementation from start to finish is as follows:

(i) The user creates a Criterium DecisionPlus (CDP) file containing the structure for the prioritization, the hierarchy of criteria in the weighted scoring, the weights, the score translations, the potential investment projects and the scores for each project against the criteria.

(ii) The user performs analysis on the projects, weights and scores.

(iii) The user outputs a spreadsheet worksheet of data.

(iv) The user cuts and pastes the worksheet for each program into a single spreadsheet workbook.

(v) The user starts the Access optimization application.

(vi) The user triggers the load of the CDP data—a visual basic (VBA) module extracts the data from the spreadsheet and inserts it into the relevant tables in the Access database.

(vii) The user views the data in the Access form and manipulates the sorting and filtering.

(viii) The user enters budget and other resource constraint information through the interface .

(ix) The user triggers a simple plan generation—a VBA module runs an algorithm which determines the year of implementation of each project starting with the highest scoring project in the first year and including further projects from down the list in each year until a constraint for the (budget or other resource) is encountered.

(x) The user views the plan and other information through Access forms containing pivot charts.

(xi) The user enters more sophisticated constraint information such as years in which the project can occur and dependencies (predecessors, dependents) between the projects.

(xii) The user triggers a full optimization of the plan—the following occurs:

(a) A VBA module calls the OPL COM object to start the optimization.

(b) The OPL COM object loads the compiled optimization file (.opl file) and starts the execution of the optimization code and the optimization itself.

(c) The optimization code loads the input data from the Access database through ODBC.

(d) The optimization itself occurs which calls into the CPLEX Mixed Integer Programming Library.

(e) The OPL COM object receives a timeout warning from CPLEX engine and displays a timeout warning.

(f) The OPL COM object receives the optimization result back from CPLEX engine.

(g) The OPL COM object executes the close-out code in the optimization script and writes the output result to the Access database.

(h) The OPL COM object passes control back to the VBA module which displays a success message box.

(i) The results of the optimization are refreshed onto the screen.

(xiii) The user uses the same pivot charts to review the outputs.

(xiv) The user can change the incremental factors on the criteria scores and rerun the optimization.

With reference back to FIG. 12 showing a score for a quantifiable investment attributes investment project having a variable character (e.g. probabilistic character), a Monte Carlo simulation may be used to produce a plan which lists the probability of a particular project occurring in a sub-period. In such an embodiment one or more of a project's input weighted sub scores would have a probability distribution over them. For example, a normal (possibly lognormal) distribution with a mean of the current value and an individually defined standard deviation is defined. A Monte Carlo analysis is performed in the following way. A table of a significant number of randomly generated score values derived using the probability distributions is pre-generated and a flag set to indicate a Monte Carlo analysis. The optimization engine is called which recognizes the flag and repeats the optimization using each of the different sets of input values. Each optimization result is written out to an output table. Once the multiple-optimizations have occurred, the proportion of time each project had occurred in a particular year is determined (e.g. in MS Access) and these are displayed in a graphical form.

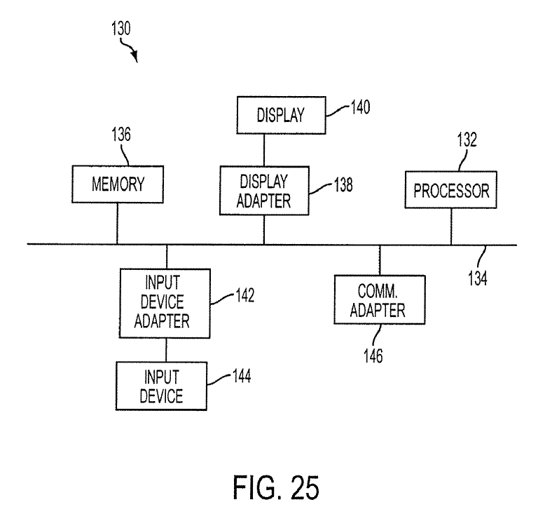

FIG. 25 shows a schematic and simplified representation of a computer system 130 on which embodiments of the present invention can be implemented.

The system 130 comprises various data processing resources such as a processor 132 coupled to a bus structure 134. Also connected to the bus structure 134 are further data processing resources such as memory 136. A display adapter 138 connects a display 140 to the bus structure 134. A user-input device adapter 142 connects a user-input device 144 to the bus structure 134. Optionally, a communications adapter 146 is provided to provide an interface for the computer system to communicate across one or more networks.

In operation the processor 132 will execute instructions that may be stored in memory 136. The results of the processing performed may be displayed to a user via the display adapter 138 and display device 140. User inputs for controlling the operation of the computer system 130 may be received via the user-input device adapter 142 from the user-input device.

It will be appreciated that the architecture of a computer system could vary considerably and FIG. 25 is only one example. Particular embodiments have been described by way of non-limiting example. It will be appreciated that variations within the scope of the invention are possible. For example, the following alternative implementations are contemplated: Alternative implementations

FIG. 3 illustrates just one particular implementation of the embodiment of FIG. 1. In another implementation, the interaction between CDP 20 and MS Access 26 is a direct link, without the use of an xls file.

Other implementations of the embodiment of FIG. 1 use alternative project definition modules 12, database modules 14 and risk reduction modules 16.

Examples of alternative project definition modules include tools available from Enterprise LSE Ltd. (www.LSE.ac.uk/Enterprise), Expert Choice Inc (www.expertchoice.com), Logical Decisions (www.logicaldecisions.com), Helsinki University of Technology (www./ipre.http/.fi), Visual Thinking International Ltd (www.visualt.com), and DecideWise International BV (www.decidewise.com).

Examples, of alternative database modules include Applix TM1, available from Applix, Inc. (www.applix.com), in combination with Microsoft Excel, available from Microsoft Corporation. In this implementation, Excel delivers the user interface and the analytic charting of data in TM1.

Another example of an alternative database module is an SAP-based solution using the SAP NetWeaver architecture, available from SAP AG (www.sap.com). Execution components of this module include: SAP Enterprise Portal SAP, SAP BI (BW), SAP WebAS. Development components include Visual Composer and SAP Developer Studio, with the development performed in Java.

Another example of an alternative database module is a custom solution using a web-based application developed in Java or Microsoft NET. This implementation is based on a standard database such as Microsoft SQL Server or Oracle. Analytics are provided through Excel or through OLAP/BI tools such as BusinessObjects, Cognos, Oracle tools or ProClarity. Or the custom solution can be constructed as a stand-alone, fully integrated software application combining some or all of the components of the invention.

Examples of alternative risk reduction modules include Frontline Systems Solver, which provides a range of optimizations engines; AIMMS from Paragon Decision Technology BV; SOPT (Smart Optimizer) from SAITECH, Inc.; and Xpress-MP Suite from Dash Optimization.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

What is claimed is:

1. A method of creating a plan of projects to invest in for an investment program, the investment program being for a period of time, comprising:
defining a plurality of investment projects, each investment project having at least one resource requirement;
determining at least one project benefit score for each investment project, the project benefit score for an investment project indicating the benefit of performing the investment project;
defining resource constraints for the investment program, the resource constraints comprising for each of a plurality of sub-periods of time within the period of time of the investment program, at least one resource constraint which constrains the resource available for investing in projects for the sub-period;
providing the resource requirements, project benefit scores and resource constraints as inputs to a risk reduction procedure which determines a plan for the investment program identifying for each sub-period of time particular investment projects to invest in, wherein the risk reduction procedure is arranged to produce a plan which satisfies the resource constraints and reduces residual risk, the residual risk comprising the combined project benefit scores of unperformed investment projects; and
displaying the plan.

2. The method of claim 1, wherein the risk reduction procedure is arranged to reduce the residual risk for each sub-period of time.

3. The method of claim 1, wherein the risk reduction procedure is arranged to reduce the residual risk at the of the period of time of the investment program.

4. The method of claim 1, wherein the period of time is a plurality of years and the sub-periods of time are years.

5. The method of claim 1, wherein determining a project benefit score for each investment project comprises:
defining a hierarchy of investment attributes for the investment program, the lowest level in the hierarchy comprising quantifiable investment attributes on which an investment project can be scored;
determining a score for each quantifiable investment attribute for each investment project; and
determining the project benefit score for each investment project based on the scores for each quantifiable investment attribute for the investment project.

6. The method of claim 5, wherein determining a project benefit score for each investment project further comprises:
assigning weightings for one or more investment attributes; and
determining the project benefit score for each investment project based on the scores for each quantifiable investment attribute for the investment project and the weightings for the one or more investment attributes.

7. The method of claim 5, wherein a first level of the hierarchy of investment attributes comprises one or more of the group of investment attributes comprising: serviceability; reputation; environmental; legal and safety; and regulatory.

8. The method of claim 1, further comprising:
after determining a project benefit score for each investment project, determining a prioritized list of the investment projects prioritized from the project with the highest project benefit score to the project with the lowest project benefit score; and
displaying the prioritized list.

9. The method of claim 6, further comprising:
after determining the project benefit score for each investment project, displaying the project benefit score for each investment project by contribution from each investment attribute from a particular level of the hierarchy of investment attributes.

10. The method of claim 1, wherein the risk reduction procedure determines a plan which includes an indication of the order in which the projects should be performed for one or more sub-periods.

11. The method of claim 5, wherein a score for one or more quantifiable investment attributes for one or more investment projects has a variable character, further comprising:
after determining a project benefit score for each investment project, determining a prioritized list of the investment projects prioritized from the project with the highest project benefit score to the project with the lowest project benefit score; and
displaying the prioritized list including an indication of the range of probable scores for projects having quantifiable investment attributes of a variable character.

12. The method of claim 1, wherein a resource requirement of the at least one resource requirement for each investment project is a project cost and a resource constraint of the at least one resource constraint for each sub-period of time comprises a capital constraint which constrains the capital available for investing in projects for the sub-period.

13. The method of claim 1, wherein a resource requirement of the at least one resource requirement for each investment project is an effort requirement and a resource constraint of the at least one resource constraint for each sub-period of time comprises an effort constraint which constrains the effort available for investing in projects for the sub-period.

14. The method of claim 13, wherein the effort requirement and effort constraint comprise a staff effort requirement and a staff effort constraint defined by skill group.

15. The method of claim 1, further comprising:
defining mandatory occurrence constraints specifying that one or more investment projects must occur; and
providing the mandatory occurrence constraints as inputs to the risk reduction procedure, wherein the risk reduction procedure is arranged to produce a plan in which said one or more specified investment projects are identified.

16. The method of claim 1, further comprising:
defining optional occurrence constraints specifying that one or more investment projects may occur in one or more of the sub-periods of time; and
providing the optional occurrence constraints as inputs to the risk reduction procedure, wherein the risk reduction procedure is arranged to produce a plan in which said investment projects may be identified in only the specified sub-periods.

17. The method of claim 1, further comprising:
defining project dependencies specifying one or more dependencies between investment projects; and
providing the project dependencies as inputs to the risk reduction procedure,
wherein the risk reduction procedure is arrange to produce which a plan which satisfies the specified dependencies.

18. The method of claim 1, further comprising:
storing the plan as a first scenario; and
determining another plan as a second scenario so that the first and second scenarios can be compared.

19. The method of claim 1, further comprising maintaining an audit trail of textual justification of changes made to produce different plans.

20. The method of claim 1, further comprising displaying the residual risk for each sub-period of time in the plan, the residual risk for each sub-period comprising the combined project benefit scores of the investment projects which are not identified in the plan for the sub-period and any preceding sub-periods.

21. The method of claim 5 wherein a score for one or more quantifiable investment attributes for one or more investment projects has a variable character.

22. The method of claim 21, further comprising using a Monte Carlo simulation to produce a plan which lists the probability of a particular project occurring in a sub-period.

23. The method of claim 1, wherein the risk reduction procedure is an optimization procedure.

24. A method of creating a plan of projects to invest in for an investment program, the investment program being for a period of time, comprising:
defining a plurality of investment projects, each investment project having at least one resource requirement;
determining at least one project benefit score for each investment project, the project benefit score for an investment project indicating the benefit of performing the investment project;
defining resource constraints for the investment program, the resource constraints comprising for each of a plurality of sub-periods of time within the period of time of the investment program, at least one resource constraint which constrains the resource available for investing in projects for the sub-period;
providing the resource requirements, project benefit scores and resource constraints as inputs to an optimization procedure which determines a plan for the investment program identifying for each sub-period of time particular investment projects to invest in, wherein the optimization procedure is arranged to produce a plan which satisfies the resource constraints and reduces residual risk, the residual risk comprising the combined project benefit scores of unperformed investment projects; and
displaying the plan.

25. A system for creating a plan of projects to invest in for an investment program, the investment program being for a period of time, comprising a processor programmed with computer-executable instructions to:
define a plurality of investment projects, each investment project having at least one resource requirement;
determine at least one project benefit score for each investment project, the project benefit score for an investment project indicating the benefit of performing the investment project;
define resource constraints for the investment program, the resource constraints comprising for each of a plurality of sub-periods of time within the period of time of the investment program, at least one resource constraint which constrains the resource available for investing in projects for the sub-period;
provide the resource requirements, project benefit scores and resource constraints as inputs to a risk reduction procedure which determines a plan for the investment program identifying for each sub-period of time particular investment projects to invest in, wherein the risk reduction procedure is arranged to produce a plan which satisfies the resource constraints and reduces residual risk, the residual risk comprising the combined project benefit scores of unperformed investment projects; and
cause a display device to display the plan.

26. A system for creating a plan of projects to invest in for an investment program, the investment program being for a period of time, comprising:
means for defining a plurality of investment projects, each investment project having at least one resource requirement;
means for determining at least one project benefit score for each investment project, the project benefit score for an investment project indicating the benefit of performing the investment project;
means for defining resource constraints for the investment program, the resource constraints comprising for each of a plurality of sub-periods of time within the period of time of the investment program, at least one resource constraint which constrains the resource available for investing in projects for the sub-period;
means for providing the resource requirements, project benefit scores and resource constraints as inputs to a risk reduction procedure which determines a plan for the investment program identifying for each sub-period of time particular investment projects to invest in, wherein the risk reduction procedure is arranged to produce a plan which satisfies the resource constraints and reduces residual risk, the residual risk comprising the combined project benefit scores of unperformed investment projects; and
means for displaying the plan.

27. A computer readable medium containing computer-executable instructions for creating a plan of projects to invest in for an investment program, the investment program being for a period of time, the computer-executable instructions comprising:
instruction code for defining a plurality of investment projects, each investment project having at least one resource requirement;
instruction code for determining at least one project benefit score for each investment project, the project benefit score for an investment project indicating the benefit of performing the investment project;
instruction code for defining resource constraints for the investment program, the resource constraints comprising for each of a plurality of sub-periods of time within the period of time of the investment program, at least one resource constraint which constrains the resource available for investing in projects for the sub-period;
instruction code for providing the resource requirements, project benefit scores and resource constraints as inputs to a risk reduction procedure which determines a plan for the investment program identifying for each sub-period of time particular investment projects to invest in, wherein the risk reduction procedure is arranged to produce a plan which satisfies the resource constraints and reduces residual risk, the residual risk comprising the combined project benefit scores of unperformed investment projects; and
instruction code for displaying the plan.
